(19) United States
(12) Patent Application Publication
(10) Pub. No.: US 2025/0199965 A1
(43) Pub. Date: Jun. 19, 2025

(54) SECURE CROSS-HOST MEMORY SHARING

(71) Applicant: Rambus Inc., San Jose, CA (US)

(72) Inventors: Evan Lawrence Erickson, Chapel Hill, NC (US); Michael Alexander Hamburg, ‘s-Hertogenbosch (NL); Helena Handschuh, Miami, FL (US); Mark Evan Marson, Carlsbad, CA (US); Taeksang Song, San Jose, CA (US)

(21) Appl. No.: 18/966,651

(22) Filed: Dec. 3, 2024

Related U.S. Application Data
(60) Provisional application No. 63/610,170, filed on Dec. 14, 2023.

(51) Int. Cl. G06F 12/14

(52) U.S. Cl. CPC G06F 12/145; G06F 12/1408; G06F 12/1483

(57) ABSTRACT

Techniques for providing secure cross-host memory sharing are described herein. A memory buffer device having processing circuitry is to receive a first request from a first initiator to share a region of memory associated with the memory buffer device with a second initiator. The processing circuitry may identify a first passcode associated with the first initiator. The processing circuitry may receive a second request from the second initiator to access the region of memory. The second request includes a second passcode. The processing circuitry may authenticate the second request using the first passcode and the second passcode. Responsive to authentication of the second request, the processing circuitry may generate a mapping between a host physical address space associated with the second initiator and a physical memory address space associated with the region of memory to enable the second initiator to access the region of memory.

### RELATED APPLICATIONS

This application claims the benefit of U.S. Provisional Application No. 63/610,170, filed Dec. 14, 2023, the entire contents of which is incorporated herein by reference.

### TECHNICAL FIELD

Aspects and embodiments of the disclosure relate generally to memory devices, and more specifically, to systems and methods for secure cross-host memory sharing.

### BACKGROUND

Modern computer systems generally include one or more memory devices, such as those on a memory module. The memory module may include, for example, one or more random access memory (RAM) devices or dynamic random access memory (DRAM) devices. A memory device may include memory banks made up of memory cells that a memory controller or memory client accesses through a command interface and a data interface within the memory device. The memory module may include one or more volatile memory devices. The memory module may be a persistent memory module with one or more non-volatile memory (NVM) devices.

### BRIEF DESCRIPTION OF THE DRAWINGS

The present disclosure is illustrated by way of example, and not by way of limitation, in the figures of the accompanying drawings.

FIG. 1 is a block diagram of a memory system with a shared memory module that includes a memory sharing authenticator for secure cross-host memory sharing, according to at least one embodiment of the present disclosure.

FIG. 2 is a process flow diagram of a method for secure cross-host memory sharing by authenticating a host using a passcode, according to at least one embodiment of the present disclosure.

FIG. 3 is a process flow diagram of a method for secure cross-host memory sharing by authenticating a host using a host identifier, according to at least one embodiment of the present disclosure.

FIG. 4 is a diagram illustrating address translation to setup memory sharing using a device-private page table, according to at least one embodiment of the present disclosure.

FIG. 5 is a diagram illustrating address translation to setup memory sharing using host-managed device memory (HDM) decoders, according to at least one embodiment of the present disclosure.

FIG. 6 is a flow diagram of a method for secure cross-host memory sharing, according to at least one embodiment of the present disclosure.

FIG. 7 is a block diagram of an integrated circuit with a memory controller, a cryptographic circuit, and a management processor, according to at least one embodiment of the present disclosure.

### DETAILED DESCRIPTION

The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format to avoid obscuring the present disclosure unnecessarily. Thus, the specific details set forth are merely exemplary. Particular implementations may vary from these exemplary details and still be contemplated to be within the scope of the present disclosure.

Datacenter architectures are evolving to support the workloads of emerging applications in Artificial Intelligence and Machine Learning that require a high-speed, low latency, cache-coherent interconnect. Compute Express Link® (CXL®) is an industry-supported cache-coherent interconnect for processors, memory expansion, and accelerators. Many central processing unit (CPU) vendors, device vendors, and datacenter vendors have adopted CXL® as a common standard, enabling an inter-operable ecosystem that supports key computing use cases included efficient accelerators, multi-server resource sharing/pooling, server memory bandwidth and capacity expansion, and efficient peer-to-peer communication.

As attacks on datacenters become more sophisticated, confidential computing standards continuously adapt to protect sensitive data and communications. To this end, the CXL® standard includes a security requirement of Integrity and Data Encryption (IDE). The CXL® IDE may be used to secure traffic within a Trusted Execution Environment (TEE). A TEE is an isolated and secure environment within which data is stored and processed. In some instances, the IDE may provide confidentiality, integrity, and replay protection for transaction layer packets for CXL® Input/Output (IO), cache, and memory protocols to ensure that data is secure from observation, tampering, deletion, insertion, and replay of packets. User data may be accordingly protected from other users. In some instances, a trusted virtual machine (TVM) may operate within the TEE such that an entity (e.g., a hypervisor) associated with the datacenter vendor may be excluded from the TEE to restrict datacenter vendor access to user data. User data may be accordingly protected from a malicious datacenter vendor.

In some instances, CXL® may provide support for multi-host memory sharing that allows memory associated with a shared memory module to be shared among multiple hosts. A fabric manager may implement multi-host memory sharing and control routing and device assignation. The fabric manager, for example, may be application logic designed and controlled by the datacenter vendor responsible for system composition and resource allocation. In some instances, the fabric manager may coordinate with multiple hosts to update page tables within a CXL® device such that multiple hosts may share the same physical memory. However, such a mechanism of cross-host memory sharing may be insecure if the datacenter vendor is untrusted. For example, a datacenter vendor may control the fabric manager to infiltrate the TEE through illicit sharing of memory to access user data stored within the shared physical memory.

Aspects and embodiments of the present disclosure address these deficiencies and other deficiencies by providing a memory sharing authenticator to enable secure cross-host memory sharing. Prior to a shared memory module enabling cross-host sharing of physical memory associated with the shared memory module, the memory sharing authenticator may authenticate the host (referred to as “owner” or “owning host” herein) to share the memory and one or more hosts (referred to as “beneficiaries” or “benefiting host(s)” herein) to benefit from the sharing. For example, a host that owns the memory to be shared may send a request to the memory sharing authenticator to allow one or more beneficiaries to access the data. In some embodiments, the request may be sent as a vendor-defined message or a standard message. In the context of CXL®, a vendor-defined message is a mechanism that allows an entity, such as a vendor, to define a custom message beyond standard CXL® message. A standard CXL® message is a set of messages and protocols that enable communication and data between devices connected via the CXL® interface. The request may include a region of memory to be shared with one or more benefitting hosts. The region of memory may be indicated by a base address and a size of the memory to be shared. A passcode associated with the region of memory may be provided by the owning host or by the memory sharing authenticator. The owning host may distribute the passcode to enable benefitting hosts/VMs to access the indicated region of memory.

In an illustrative example, the owning host may share the passcode associated with the region of memory to a benefiting host. The owning host may send the passcode to the benefiting host via transmission control protocol (TCP), in-band CXL®, a message passing interface (MPI), or the like. The benefiting host may send a request including the passcode to the shared memory module to access the region of memory. For example, the benefiting host may send the passcode to the shared memory module as part of a vendor-defined message or a CXL® standard message. The memory sharing authenticator may authenticate the passcode provided by the benefiting host by ensuring it matches the passcode associated with the owner.

Responsive to authenticating the benefiting host, the shared memory module may setup memory sharing to enable the benefiting host to access the indicated region of memory. To setup the sharing, the shared memory module may update one or more address translation tables to map an allocated region of Host Physical Address (HPA) space associated with the benefiting host to a Physical Memory Address (PMA) range associated with the region of shared memory. The region of HPA space is useable by the benefiting host to access the region of shared memory. In some embodiments, the fabric manager and/or hypervisor associated with the benefiting host may setup the memory sharing responsive to authentication of the benefitting host. For example, the fabric manger may setup one or more Host-managed Device Memory (HDM) decoders associated with the benefiting host. The HDM decoders determine what HPA range will be mapped to the PMA range of the shared memory module associated with the shared region of memory. Accordingly, host physical addresses associated with the owner host and the benefiting host may indicate the same PMA range associated with the shared region of memory.

By restricting access to a shared memory module until benefiting hosts are authenticated by the shared memory module, as opposed to allowing the fabric manager to enable memory sharing, untrusted fabric manager involvement in cross-host memory sharing is limited, thereby increasing security associated with cross-host memory sharing. Accordingly, the shared memory module may ensure that the owner of the shared memory has requested sharing of memory, and the beneficiaries requesting access to the shared memory are properly authenticated prior to accessing the shared memory.

In some embodiments, the memory sharing authenticator may be part of a device that supports the CXL® technology, such as a CXL® shared memory module. The CXL® shared memory module may include a CXL® controller or a CXL® memory expansion device (e.g., CXL® memory expander System on Chip (SoC)) that is coupled to DRAM (e.g., one or more volatile memory devices) and/or persistent storage memory (e.g., one or more NVM devices). The CXL® memory expansion device may include a management processor. The CXL® memory expansion device may use an IME (Inline Memory Encryption) circuit to encrypt the host's unencrypted data before storing it in the DRAM and to decrypt the encrypted data from the DRAM before returning it to the host. The memory sharing authenticator may authenticate access to the shared memory module. The memory sharing authenticator may perform aspects and implementations of the techniques described herein.

It may be noted that the term “host” as used herein may generally refer to a computer or device that initiates communication or requests in a network. More broadly, a host may be any system that hosts applications or services. In the context of virtualization, a host may be a physical machine or server running a hypervisor that manages one or more virtual machines (VMs). In some embodiments, the host may be a VM running on a physical server with a hypervisor, and the VM may initiate cross-host memory sharing with another VM, as described herein. In some instances, the host, as described herein, may be an initiator. An initiator is a device (such as a server, a computer system, or a central processing unit (CPU)) that initiates requests to access memory resources.

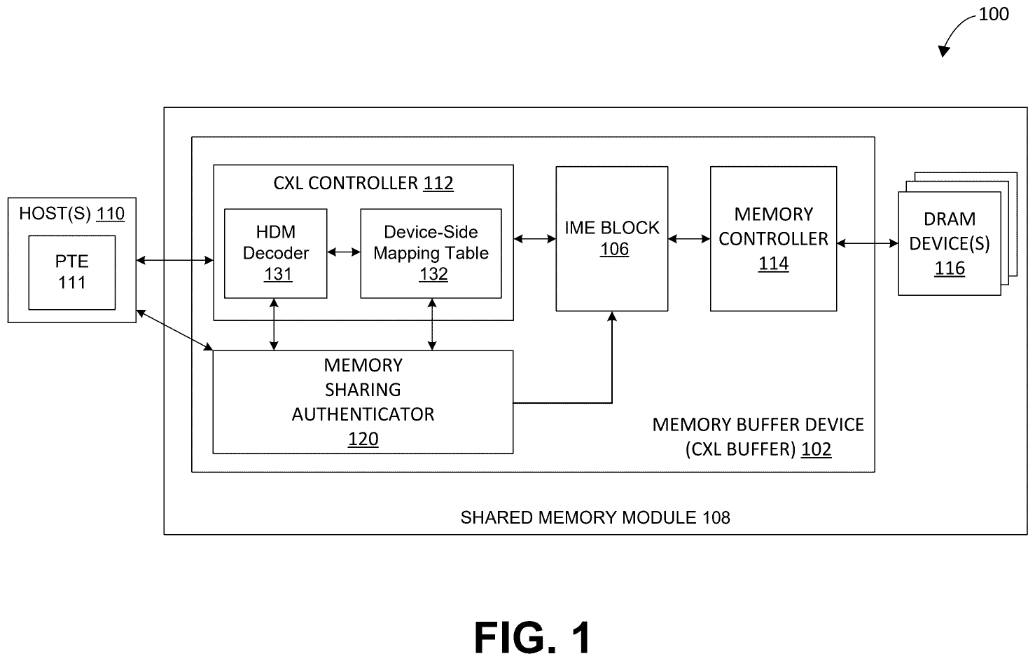

FIG. 1 is a block diagram of a memory system 100 with a shared memory module 108 with a memory controller 114 according to at least one embodiment. The shared memory module 108 is accessible by one or more host(s) 110 such that multiple hosts may access (e.g., read, write, etc.) physical memory associated with the shared memory module 108. In one embodiment, the shared memory module 108 includes a memory buffer device 102 and one or more DRAM device(s) 116. In at least one embodiment, the one or more DRAM devices 116 may be disposed on more than one channel, controlled by more than one memory controller. In one embodiment, the memory buffer device 102 is coupled to one or more DRAM device(s) 116 and one or more hosts 110. In another embodiment, the memory buffer device 102 is coupled to a fabric manager that is operatively coupled to the one or more host(s) 110. In another embodiment, the memory buffer device 102 is coupled to both the one or more hosts 110 and the fabric manager. A fabric manager is software executed by a device, such as a BMC (baseboard management controller) or CPU, that manages configurations and connections between multiple entities in a network fabric. The network fabric is a network topology in which components pass data to each other through interconnecting switches. A network fabric includes hubs, switches, adapter endpoints, etc. The fabric manager may communicate with software running on a host machine, an orchestrator, embedded software running on a baseboard management controller (BMC), embedded firmware running on another CXL® device or CXL® switch, or a state machine running within the CXL® buffer 102.

When a host 110 is added to the system, the host 110 may undergo an initialization process. This process may involve identifying capabilities of the host 110, establishing connection links, and negotiating configurations. In some embodiments, memory allocated to the host 110 may be mapped into a Host Physical Address (HPA) space associated with the host 110. In one embodiment, each virtual machine running on the hosts 110 includes one or more host-managed page-table entry (PTE) 111. Virtual addresses associated with the host 110 may be used by programs/applications to access memory associated with the host 110. The virtual machine may use the one or more PTE 111 to convert virtual address to HPAs that may be sent over the CXL® link to the shared memory module 108. A host-managed device memory (HDM) decoder(s) 131 and/or a device-side mapping table(s) 132 in the CXL® controller 112 may map/translate HPAs to PMAs associated with the shared memory module 108. HDM decoder(s) 131 may be setup managed by one or more of the fabric manager, the associated host 110, a hypervisor, or the like. It is appreciated that PTE 111, HDM decoder 131, and device-side mapping table 132 are used herein by way of example, and not by way of limitation, noting that alternative techniques can be employed to translate virtual addresses to HPAs at the host(s) 110 and to translate HPAs to PMAs at the shared memory module 108.

In one embodiment, the memory buffer device 102 includes a memory sharing authenticator 120 to authenticate one or more hosts 110 for secure cross-host memory sharing. For example, memory associated with the shared memory module 108 may be owned by and allocated to a first host of the host(s) 110. The first host may request a region of its allocated memory to be shared with one or more other hosts of the host(s) 110. For example, the first host may send (e.g., via a vendor-defined message, a standard CXL® message, mailbox, etc.) a request to the shared memory module 108 that the region of memory be shareable with a second host of the host(s) 110. Responsive to receiving the request, the memory sharing authenticator 120 may generate a passcode that is useable to enable access to the region of memory. The passcode may be generated with a True Random Number Generator (TRNG), a key generation algorithm, etc.; and may incorporate an identifier associated with the first and/or the second host. In some embodiments, the memory sharing authenticator may associate the passcode with the first host and information about the region of memory to be shared, such as the size of the region. The memory sharing authenticator 120 may send the passcode and associated information about the shared region of memory to the first host.

The first host may send (e.g., via TCP/IP, in-band CXL®, MPI, etc.) the passcode received from the memory sharing authenticator 120 to the second host. The second host may request access to the region of memory by providing (e.g., via a vendor-define message, a standard CXL® message, etc.) the passcode to the shared memory module 108. The memory sharing authenticator 120 may authenticate the passcode and use the passcode to locate the region of memory to be shared with the second host. In some embodiments, the shared memory module 108 may update one or more HDM decoders and/or device-side mapping tables (e.g., dynamic-capacity-device extent lists, device-private page tables, etc.) to map an HPA range associated with the second host to a PMA range associated with the region of memory such that the second host may allocate to the region of memory using the HPA range. Accordingly, the first and the seconds hosts may use independent HPA ranges to access the region of memory owned and shared by the first host.

In some embodiments, the fabric manager and/or a hypervisor associated with the second host may setup the memory sharing responsive to the memory sharing authenticator 120 authenticating the second host. For example, the fabric manger may setup one or more (HDM) decoders 131 associated with the second host and map an HPA range to the PMA range of the shared memory module associated with the shared region of memory. In such an embodiment, the sharing authenticator 120 may authenticate the sharing prior to setup or restrict access to the shared memory until the sharing is authenticated. Accordingly, back-door sharing initiated by the datacenter vendor may be prevented as access is restricted until authentication between the owning host and benefitting host occurs.

In one embodiment, the memory buffer device 102 may include an error correction code (ECC) block (e.g., ECC circuit) to detect and correct errors in cache lines being read from a DRAM device(s) 116 and an IME block 106 to generate a message authentication code (MAC) for each cache line to provide cryptographic integrity on accesses to the respective cache line. In a further embodiment, the memory buffer device 102 includes a CXL® controller 112 and a memory controller 114. The CXL® controller 112 is coupled to host(s) 110 and the fabric manager controls allocation of memory from the shared memory module 108. The memory controller 114 is coupled to the memory sharing authenticator and the one or more DRAM devices 116. In a further embodiment, the memory buffer device 102 includes a management processor and a root of trust. In at least one embodiment, the management processor receives one or more management commands through a command interface between the host 110 (or fabric manager) and the management processor. In at least one embodiment, the memory buffer device 102 is implemented in a memory expansion device, such as a CXL® memory expander SoC of a CXL NVM module or a CXL module. The memory buffer device 102 may encrypt unencrypted data (e.g., plain text or cleartext user data), received from a host 110, using the IME block 106 to obtain encrypted data before storing the encrypted data in DRAM device(s) 116.

Generally, IDE in the CXL controller 112 may decrypt data and deliver plaintext to the Inline Memory Encryption (IME) block 106. In some cases, the IME (Inline Memory Encryption) block 106 may receive data that is encrypted for transmission across the link. In at least one embodiment, the IME block 106 is an IME engine. In another embodiment, the IME block 106 is an encryption circuit or encryption logic. The ECC block may receive the encrypted data from the IME block 106. The ECC block may generate ECC information associated with the encrypted data. The encrypted data and the ECC information may be organized as cache line data. The memory controller 114 may receive the cache line data from the ECC block and store the cache line data in the DRAM device(s) 116. It should be noted that the memory buffer device 102 may receive unencrypted data, but may also receive data that is encrypted as it traverses a link (e.g., the CXL link). This encryption is usually a link encryption, generally referred to in CXL as integrity and data encryption (IDE). The link encryption, in this case, would not persist to DRAM as the CXL controller 112 in the shared memory module 108 may decrypt the link data and verify its integrity prior to the flow described herein, where the IME block 106 encrypts the data. Although “unencrypted data” is used herein, in other embodiments, the data may be encrypted data that is encrypted by the memory buffer device 102 using a key only used for the link and thus cleartext data exists within the SoC after the CXL controller 112 and thus needs to be encrypted by the IME block 106 to provide encryption for data at rest.

In at least one embodiment, the CXL controller 112 includes two interfaces: a host memory interface (e.g., CXL.mem) and a management interface (e.g., CLX.io, SMBus, I2C, I3C, etc). The host memory interface may receive, from the one or more hosts 110, one or more memory access commands of a remote memory protocol, such as Compute Express Link (CXL) protocol. In some embodiments, Gen-Z, Open Memory Interface (OMI), Open Coherent Accelerator Processor Interface (OpenCAPI), and the like can be used for a host memory interface for the shared memory module 108. The management interface may receive, from the host 110 or the fabric manager by way of the management processor, one or more management commands of the remote memory protocol.

In at least one embodiment, the IME block 106 receives a data stream from a host 110 and encrypts the data stream into the encrypted data, and provides the encrypted data to the ECC block and the memory controller 114. The memory controller 114 stores the encrypted data in the DRAM device(s) 116 along with the ECC information as the cache line data.

In some embodiments, the shared memory module 108 has persistent memory backup capabilities where the management processor 122 may access the encrypted data and transfer the encrypted data from the DRAM device(s) 116 to persistent memory (not illustrated in FIG. 1) in the event of a power-down event or a power-loss event. The encrypted data in the persistent memory is considered data at rest. In at least one embodiment, the management processor transfers the encrypted data to the persistent memory using an NVM controller (e.g., NAND controller).

The IME block 106 may include multiple encryption functions, such as a first encryption function that uses AES-128 encryption and a second encryption function that uses AES-256 encryption. In other embodiments, the encryption functions may also provide cryptographic integrity, such as using a message authentication code (MAC). In other embodiments, the cryptographic integrity may be provided separately from the encryption function. In some cases, the strength of the MAC and encryption algorithms may be different. The first encryption function may have a first encryption strength, such as AES-256 encryption. In at least one embodiment, the IME block 106 is an IME engine with two encryption functions. In another embodiment, the IME block 106 includes two separate IME engines, each having one of the two encryption functions. In another embodiment, the IME block 106 includes a first encryption circuit for the first encryption function and a second encryption circuit for the second encryption function. Alternatively, additional encryption functions may be implemented in the IME block 106. The memory controller 114 may receive the encrypted data from the IME block 106 and store the encrypted data in the DRAM device(s) 116 from the IME block 106.

In at least one embodiment, the MAC may be calculated on a first encrypted data stored with a second encrypted data as part of the algorithm (e.g., AES) or separately with a different algorithm. The memory controller 114 may receive the encrypted data from the IME block 106 and store the encrypted data in the DRAM device(s) 116. The host-to-unencrypted memory path may bypass the IME block 106 for all host transactions. In at least one embodiment, the encryption may be serialized (e.g., a first time for memory (DRAM) storage and a second time with a second standard for persistent storage). As described herein, the keys may be stored in persistent memory storage. The persistent memory storage may be used to securely store and restore the encrypted contents of the DRAM to a previous state that may be accessed by the host and restore the keys necessary to decrypt this data.

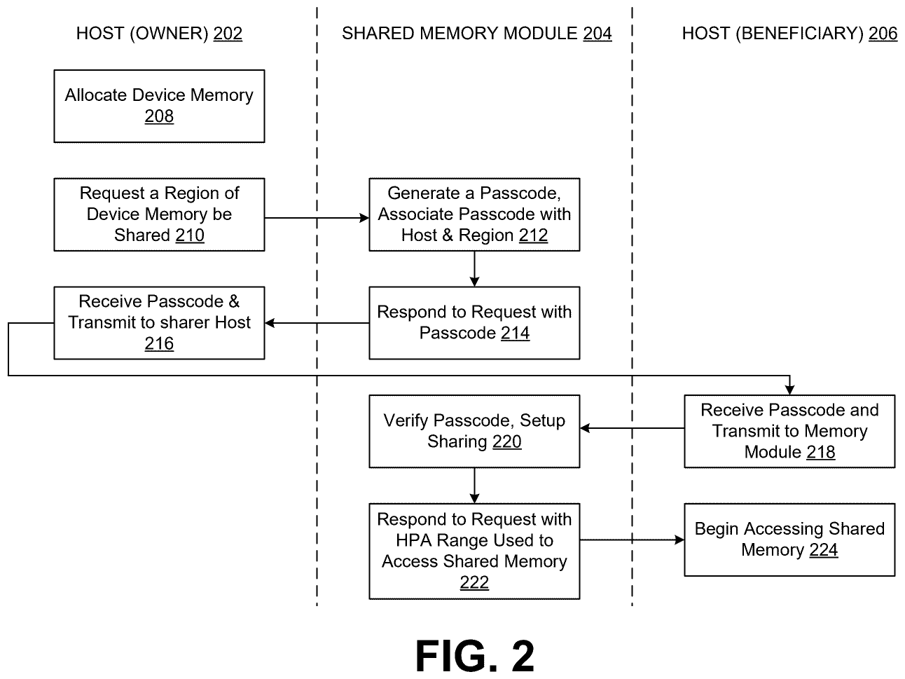

FIG. 2 is a process flow diagram of a method 200 for secure cross-host memory sharing by authenticating a host using a passcode, according to at least one embodiment of the present disclosure. The method 200 may be performed by processing logic that may include hardware (e.g., circuitry, dedicated logic, programmable logic, microcode, etc.), software (e.g., instructions run on a processing device to perform hardware simulation), firmware, or any combination thereof. In one embodiment, the method 200 may be performed by the memory buffer device 102 of FIG. 1, a memory expansion device, a shared memory module 108 of FIG. 1, and/or an integrated circuit including a memory sharing authenticator 120 of FIG. 1.

For simplicity of explanation, the method 200 of this disclosure is depicted and described as a series of acts. However, acts in accordance with this disclosure may occur in various orders and/or concurrently, and with other acts not presented and described herein. Furthermore, not all illustrated acts may be required to implement the method 200 in accordance with the disclosed subject matter. In addition, those skilled in the art will understand and appreciate that the method 200 could alternatively be represented as a series of interrelated states via a state diagram or events.

The method 200 begins at block 208 when a host 202, operatively coupled to a shared memory module 204, is allocated device memory from the shared memory module 204. In some embodiments, the host 202 may include host(s) 110 of FIG. 1, and the shared memory module 204 may include shared memory module 108 of FIG. 1. In some embodiments, the host 202 is the owner of the allocated device memory.

At block 210, the host 202 sends a request to the shared memory module 204 to share a region of device memory allocated to the host 202. In some embodiments, the request may be sent to the shared memory module 204 using a vendor-defined message (VDM) associated with an Input/Output (I/O) protocol. For example, the VDM may be a custom message that expands upon existing messaging capabilities associated with Peripheral Component Interconnect Express (PCIe) and/or the CXL.io protocol. In some embodiments, the request may be sent to the shared memory module 304 using a standard message associated with an I/O protocol. For example, the request may be sent using a standard CXL message of a set of messages and protocols that enable communication and data between devices connected via a CXL interface or sideband interface (e.g., SMBus, I2C, I3C, etc).

At block 212, the shared memory module 204 generates a passcode. In some embodiments, the shared memory module 204 may associate the passcode with the host 202 and the region of device memory to be shared. The shared memory module 204 may generate the passcode with a True Random Number Generator (TRNG), a key generation algorithm, or the like. In some embodiments, the passcode may incorporate an identifier associated with the host 302 and/or an identifier associated with the host 306. For example, the shared memory module 204 may combine a random number generated using a TRNG and an identifier associated with the host 202 to generate the passcode. In some embodiments, the passcode may be the identifier associated with the host 202 or the host 206. In some embodiments, the passcode may be generated by the host 202 transmitted to the memory module. In some embodiments, the passcode may be a cryptographic key such as a public/private key pair. In some embodiments, the passcode may be useable (e.g., by the host 302, the host 306, or another host) only once or used a predetermined number of instances to access the indicated region of memory. In some embodiments, host 302 may revoke the passcode such that the passcode is not useable to access the indicate region of memory. For example, the host 302 may transmit (e.g., via a VDM, a standard message, etc.) a request to revoke the passcode. Responsive to receiving the request, the memory module may disassociate the passcode from the region of memory. It is appreciated that the passcode may be generated by either the host 302 or the memory module 304 using any combination of random number generators, host identifiers, cryptographic keys, identifiers associated with the region of memory to be shared, and the like.

At block 214, the shared memory module 204 responds to the request with the passcode. For example, the shared memory module 204 may transmit the passcode to the host 202. As indicate above, in some embodiments, the host 202 may generate the passcode. In such an embodiment, at block 214, the shared memory module 204 may transmit an indication to the host 202 that the passcode has been successfully associated with the region of memory.

At block 216, the host 202 receives the passcode and transmits the passcode to host 206. The host 202 may transmit the passcode to the host 206 using one or more communication mechanisms. For example, the host 202 may transmit the passcode to the host 206 via TCP/IP, Hypertext Transfer Protocol (HTTP), in-band CXL, MIP, etc.

At block 218, the host 206 receives the passcode from the shared memory module 204 and transmits the passcode to the shared memory module 204. The host 206 may send the passcode using a VDM, a standard message, or the like.

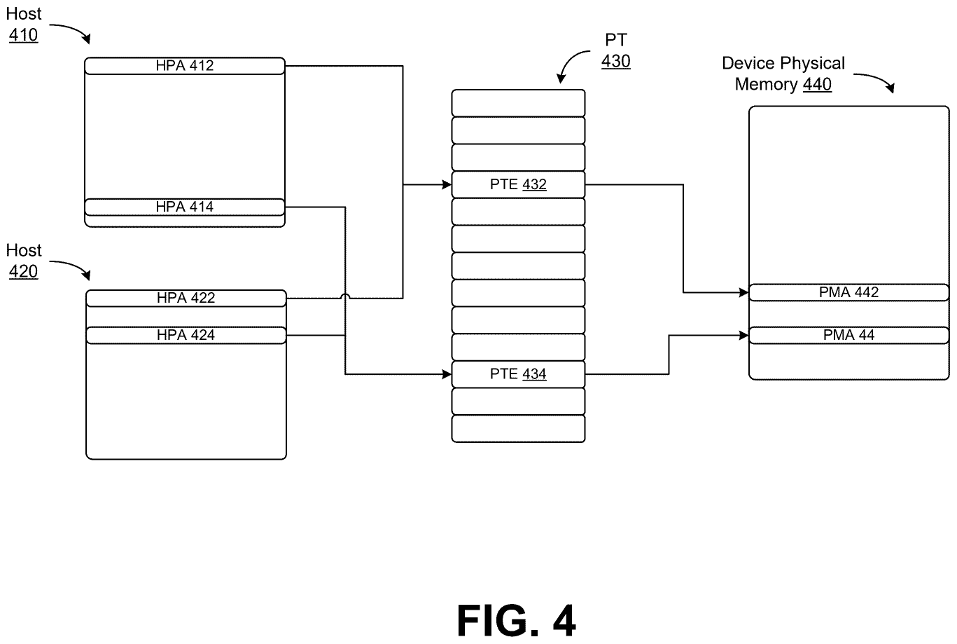

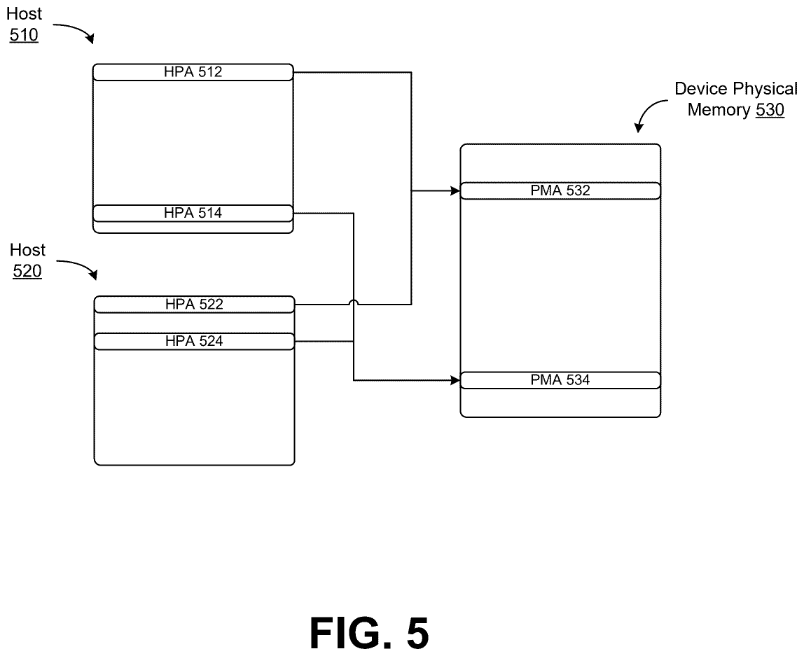

At block 220, the shared memory module 204 verifies the passcode and sets up sharing of the region of device memory with the host 206. Responsive to failing to authenticate the host 206 using the passcode, the shared memory module 204 may provide such an indication to the host 206. Responsive to successfully authenticating the host 206, the shared memory module 204 may setup sharing of the region of device memory associated with the passcode. In some embodiments, memory sharing may be setup in coordination with a fabric manager associated with the host 206 and/or the host 206 itself. For example, the fabric manager may setup HDM decoders associated with the host 206 to directly map a HPA range associated with the host 206 to a PMA range associated with the region of device memory, as described in detail below with respect to FIG. 5. In some embodiments, memory sharing may be setup by the memory module 204 without coordination from the fabric manager or the host 206. For example, responsive to authentication the host 206, the shared memory module 204 may update one or more address translation tables to map an HPA range associated with the host 206 to a PMA range associated with the region of device physical memory, as described in detail below with respect to FIG. 4.

In some embodiments, the host 206 may provide an HPA block of the same size as an HPA block that host 202 is to share with the host 206 for the host 206 and use HPA block to send read and/or write commands. The HPA block may be selected by the fabric manager and/or the host to allocate a region HPA space that host 206 may use to access the region device memory.

At block 222, the shared memory module 204 responds to the request sent at block 218 with a host physical address (HPA) range used to access the region of device memory.

At block 224, the host 206 may begin accessing the region of device memory using the HPA range. In some embodiments, the host 206 may have read-only access to the region of device memory such that the host 206 may not write to or otherwise modify data associated with the region of device memory. In some embodiments, once the passcode is verified and sharing is setup, the host 206 may subsequently access the shared region of device memory without additional authentication. In other embodiments, the passcode is sent with each subsequent access to the shared region of device memory such that the host 206 is authenticated prior to each access.

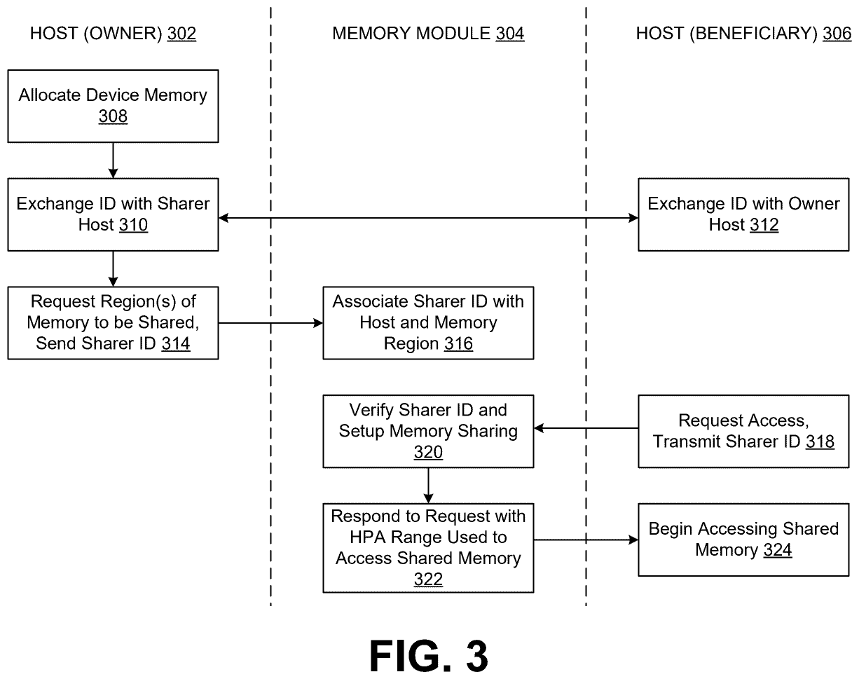

FIG. 3 is a process flow diagram of a method 300 for secure cross-host memory sharing by authenticating a host using a host identifier, according to at least one embodiment of the present disclosure. The method 300 may be performed by processing logic that may include hardware (e.g., circuitry, dedicated logic, programmable logic, microcode, etc.), software (e.g., instructions run on a processing device to perform hardware simulation), firmware, or any combination thereof. In one embodiment, the method 300 may be performed by the memory buffer device 102 of FIG. 1, a memory expansion device, a shared memory module 108 of FIG. 1, and/or an integrated circuit including a memory sharing authenticator 120 of FIG. 1.

For simplicity of explanation, the method 300 of this disclosure is depicted and described as a series of acts. However, acts in accordance with this disclosure may occur in various orders and/or concurrently, and with other acts not presented and described herein. Furthermore, not all illustrated acts may be required to implement the method 300 in accordance with the disclosed subject matter. In addition, those skilled in the art will understand and appreciate that the method 300 could alternatively be represented as a series of interrelated states via a state diagram or events.

The method 300 begins at block 308 when a host 302, operatively coupled to a shared memory module 304, is allocated device memory from the shared memory module 304. In some embodiments, the host 302 may include host(s) 110 of FIG. 1, and the shared memory module 304 may include shared memory module 108 of FIG. 1. In some embodiments, the host 302 may be the owner of the allocated device memory.

At block 310, the host 302 exchanges identifiers (IDs) with the host 306. For example, the host 302 may be a virtual machine (VM) in a datacenter. In some embodiments, the ID may be a unique ID assigned to the VM by the virtualization platform or the hypervisor it is running on to distinguish and manage VMs within the datacenter environment. In some embodiments, the ID may be an Internet Protocol (IP) address, or a Media Access Control (MAC) address associated with the VM. At block 310, the host 302 may provide the ID associated with the host 302 to the host 306. In some embodiments, block 310 can be omitted and block 312 may proceed after block 308.

At block 312, the host 306 exchanges identifiers with the host 302. For example, the ID may be a unique ID assigned by to host 306 by a virtualization platform or a hypervisor, an IP address, a MAC address, or the like. At block 312, the host 306 may provide the ID associated with the host 306 to the host 302.

At block 314, the host 302 sends a request to the memory module 304 to share a region of device memory allocated to the host 302. The request may be sent to the shared memory module 304 using a VDM, a standard message, or the like. In some embodiments, the request may include the ID associated with the host 306 and/or the ID associated with the host 302.

At block 316, the memory module 304 may associate the ID corresponding to the host 306 with the region of memory to be shared. In some embodiments, the ID corresponding to the host 302 may be associated with the region of memory. The memory module 304 may store the identifiers associated with the host 302 and the host 306.

At block 318, the host 306 may send a request to the memory module 304 to access the region of memory. In some embodiments, the request may include an identifier associated with the host 306. In some embodiments, the request may include an identifier associated with the host 302.

At block 320, the memory module 304 may verify the identifier associated with and provided by the host 306. To verify the identifier of the host 306, the memory module 304 may verify that the identifier of the host 306 is associated with the region of memory to be shared. In some embodiments, the memory module 304 may verify that the identifier associated with the host 302 received from the host 306 is associated with the region of memory. Responsive to successful verification of the identifier associated with the host 302 and/or successful verification of the identifiers associated with the host 306, the memory module 304 may setup memory sharing. In some embodiments, memory sharing may be setup in coordination with a fabric manager associated with the host 206 and/or the host 206 itself, as described below with respect to FIG. 5. In some embodiments, memory sharing may be setup by the memory module 204 without coordination from the fabric manager or the host 206, as described below with respect to FIG. 4.

At block 322, the shared memory module 204 may respond to the request sent at block 318 with an HPA range used to access the region of device memory.

At block 324, the host 306 may begin accessing the region of device memory using the HPA range. In some embodiments, the host 306 may have read-only access to the region of device memory such that the host 306 may not write to or otherwise modify data associated with the region of device memory.

FIG. 4 is a diagram 400 illustrating address translation to setup memory sharing using a device-private page table, according to at least one embodiment of the present disclosure. The diagram 400 includes a host 410, a host 420, a page table (PT) 430, and a device physical memory 440. Diagram 400 may include similar elements as illustrated in memory system 100, as described with respect to FIG. 1. Diagram 400 may also include one or more similar elements as illustrated with respect to FIG. 2 and FIG. 3, respectively. It should be noted that elements of FIG. 1, FIG. 2, and FIG. 3 may be used herein to help described FIG. 4. For example, host 410 may correspond to an owning host, such as host 202 of FIG. 2, and host 420 may corresponding to a benefiting, such as host 206 of FIG. 2.

In some embodiments, the operations described with respect to FIG. 4 may be performed in response to one or more of the above-described authentication procedures to enable cross-host sharing of memory. For example, host 410 may send a request to a memory module, such as shared memory module 108, to share a region of device physical memory 440 with host 420. The setup of a region of memory to be shared may be setup using a passcode, as described above, such that subsequent accesses to the shared memory do not require authentication. Accordingly, the operations described with respect to FIG. 4 may be performed in response to successful authentication of the setup of the region of memory to be shared.

In some embodiments, after successfully authenticating the setup of the region of device physical memory, the host 420 may subsequently access the region of device physical memory using a passcode provided by the host 420. The memory module may authenticate the host 420 using the provided passcode according to one or more authentication procedures upon each subsequent access.

To setup cross-host memory sharing between the host 410 and the host 420, HPAs associated with the host 410 and the host 420 may be mapped to the same location in device physical memory 440 based one or more page table entries associated with a page table (PT 430) within the shared memory module. In some embodiments, the host 410, a fabric manager, and/or a hypervisor may map HPA 412 to a logical physical address (LPA) associated with the page table entry (PTE) of the PT 430. For example, the fabric manager associated with the host 410 may program one or more HDM decoders associated with the host 410 such that the one or more HDM decoders convert the HPA 412 to an LPA associated with the PTE 432. The host 420, a fabric manager, and/or a hypervisor associated with the host 420 may similarly cause the HPA 422 to be mapped/translated to an LPA associated with PTE 432. For example, a separate HDM decoder associated with the host 420 may convert the HPA 422 to the LPA associated with the PTE 432.

In some embodiments, additional address translation may occur host-side to obtain an HPA. For example, page tables residing on the hosts 410 and 420 may convert virtual addresses to physical addresses. In some embodiments, those physical addresses may additionally be translated (e.g., via a hypervisor page tables, page tables residing managed by the CPU, etc.) to HPAs.

The PT 430 may be a data structure of multiple page table entries that each hold a mapping/translation between a HPA and a physical memory address (PMA) associated with the device physical memory 440. For example, the PT 430 includes a PTE 432 that maps both the HPA 412 and the HPA 422 to a PMA 442. Accordingly, the memory module may utilize the PTE 432 to map the HPA 412 and the HPA 422 to the same PMA 442 such that the host 410 and the host 420 may use respective HPAs to share the same region of physical memory corresponding to the PMA 442. Similarly, the memory module may utilize the PTE 434 to map the HPA 414 and the HPA 424 to the same PMA 444 to enable sharing of the region of memory associated with the PMA 444. Because the authentication of the hosts and address mapping/translation is managed by the memory module, cross-host device sharing may be setup with minimal host involvement. Once the mapping is authenticated and the shared memory is setup, the hosts 410 and 420 may access the shared region of device physical memory 440 without additional authentication.

FIG. 5 is a diagram 500 illustrating address translation to setup memory sharing using host-managed device memory (HDM) decoders, according to at least one embodiment of the present disclosure. The diagram 500 includes a host 510, a host 520, and a device physical memory 530. Diagram 500 may include similar elements illustrated in memory system 100, as described with respect to FIG. 1. Diagram 500 may also include one or more similar elements illustrated with respect to FIG. 2 and FIG. 3, respectively. It should be noted that elements of FIG. 1, FIG. 2, and FIG. 3 may be used herein to help described FIG. 4. For example, host 510 may correspond to an owning host, such as host 202 of FIG. 2, and host 520 may corresponding to a benefiting host, such as host 206 of FIG. 2.

In some embodiments, the operations described with respect to FIG. 5 may be performed in response to one or more of the above-described authentication procedures to enable cross-host sharing of memory. For example, host 510 may send a request to a memory module, such as shared memory module 108, to share a region of device physical memory 540 with host 520. In some embodiments, host 520 may access the region of device physical memory using a passcode provided by the host 520. The memory module may authenticate the host 520 using the provided passcode according to one or more authentication procedures described above. The operations described with respect to FIG. 5 may be performed in response to the successful authentication of the host 520.

To setup cross-host memory sharing between the host 510 and the host 520, HPAs associated with the host 510 and the host 520 may be directly mapped/translated to the same location in device physical memory 530 by one or more HDM decoders associated with the hosts 510 and 520. For example, a fabric manager may program one or more HDM decoders associated with the host 510 such that the one or more decoders convert the HPA 512 to a PMA 532. One or more other HDM decoders associated with the host 520 may map HPA 522 to PMA 532. HPA 514 and HPA 524 may be similarly mapped to the PMA 534. By restricting cross-host memory sharing until authentication is complete, a potentially untrusted fabric manager and/or hypervisor may setup memory sharing without the associated security risk.

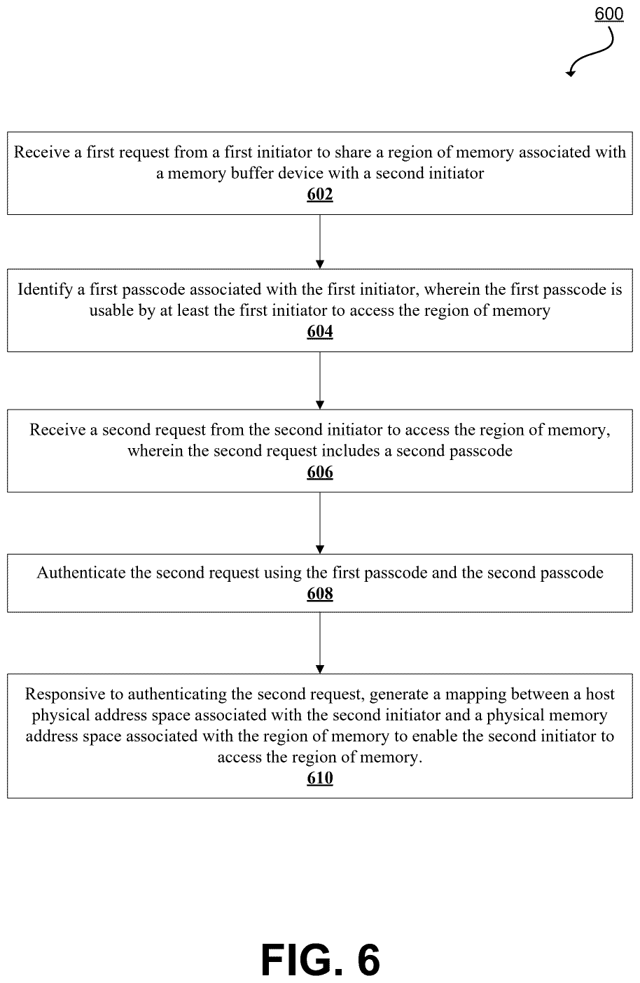

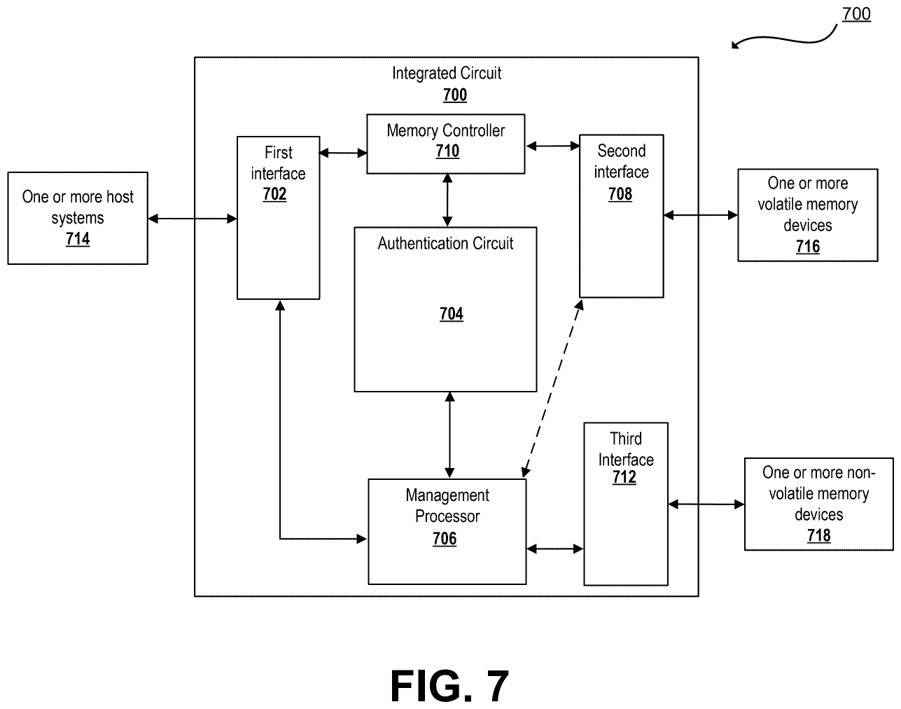

FIG. 6 is a flow diagram of a method 600 for secure cross-host memory sharing, according to at least one embodiment of the present disclosure. The method 600 may be performed by processing logic that may include hardware (e.g., circuitry, dedicated logic, programmable logic, microcode, etc.), software (e.g., instructions run on a processing device to perform hardware simulation), firmware, or any combination thereof. In one embodiment, the method 600 may be performed by the memory buffer device 102 of FIG. 1. In another embodiment, the method 600 may be performed by a memory expansion device. In another embodiment, the method 600 may be performed by the shared memory module 108 of FIG. 1. In another embodiment, the method 600 may be performed by memory sharing authenticator 120 of FIG. 1. In another embodiment, the method 600 may be performed by an integrated circuit 700 of FIG. 7. Alternatively, other devices may perform the method 600. Although shown in a particular sequence or order, unless otherwise specified, the order of the operations may be modified. Thus, the illustrated embodiments should be understood only as examples, and the illustrated operations may be performed in a different order, and some operations may be performed in parallel. Additionally, one or more operations may be omitted in various embodiments. Thus, not all operations are required in every embodiment.

The method 600 begins at block 602. At block 602, the processing logic receive a first request from a first initiator to share a region of memory associated with a memory buffer device with a second initiator.

At block 602 of method 600, the processing logic identifies a first passcode associated with the first initiator. The first passcode is useable by at least the first initiator to access the region of memory. In some embodiments, to identify the first passcode associated with the first initiator, the processing logic is to generate the first passcode based on an identifier associated with the first initiator. In some embodiments, to identify the first passcode associated with the first initiator, the processing logic is to receive the first passcode from the first initiator. In some embodiments, the first passcode may be generated by the first initiator. In some embodiments, the first passcode may be an identifier (e.g., an IP address, a MAC address, etc.) associated with the first initiator. In some embodiments, the first passcode may include an identifier associated with the region of memory. For example, the first passcode may include a logical address, or a physical memory address associated with the region of memory. In some embodiments, the first passcode may be a public-private key pair.

At block 604 of method 600, the processing logic receives a second request from the second initiator to access the region of memory. The second request includes a second passcode.

At block 606 of method 600, the processing logic receives a second request from the second initiator to access the region of memory. The second request includes a second passcode.

At block 608 of method 600, the processing logic authenticates the second request using the first passcode and the second passcode.

At block 610 of method 600, responsive to authenticating the second request, the processing logic generates a mapping between a host physical address space associated with the second initiator and a physical memory address space associated with the region of memory to enable the second initiator to access the region of memory. In some embodiments, the processing logic is to include the mapping within an internal address translation table associated with the memory buffer device. In some embodiments, the second initiator has read-only access to the region of memory. In some embodiment, to provide the second initiator with access to the region of memory, the processing logic may transfer or copy data associated with the region of memory to device memory allocated by the second initiator. In some embodiments, to provide the second initiator with access to the region of memory, processing logic may transfer the region of memory into an address space of the second initiator by updating one or more internal address translation tables. In some embodiments, the second initiator may have access to a version of the first initiator's shared data that has been processed by the device. Processing of the shared data can occur in response to authenticating the request to share the region of memory.

In some embodiments, processing logic may update the mapping/translation within the internal address translation table only after authenticating the second request and confirming that a configuration of the region of memory matches the configuration of the second passcode. For example, the configuration of the second passcode may indicate an association with the region memory. Responsive to determining that the second passcode is associated with the region of memory, the processing logic may update the internal address translation table mapping. Responsive to determining that the second passcode is not associated with the region of memory, the processing logic may refrain from updating the internal address translation table mapping. In some embodiments, the processing logic may restrict access to the region of memory until the first request is authenticated and the second request is authenticated.

In some embodiments, the processing logic is further to receive a third request from the first initiator to revoke access associated with the second initiator to the region of the memory. The processing logic is further to invalidate the first passcode. The processing logic is further to remove the mapping between the host physical address space associated with the second initiator and the physical memory address space associated with the region of memory associated with the memory buffer device.

FIG. 7 is a block diagram of an integrated circuit 700 with a memory controller 710, an authentication circuit 704, and a management processor 706 according to at least one embodiment of the present disclosure. In at least one embodiment, the integrated circuit 700 is a controller device that may communicate with one or more host systems 714 using a cache-coherent interconnect protocol (e.g., the CXL®) protocol). The integrated circuit 700 may be a device that implements the CXL® standard. The CXL® protocol may be built upon physical and electrical interfaces of a PCI Express® standard with protocols that establish coherency, simplify the software stack, and maintain compatibility with existing standards. The integrated circuit 700 includes a first interface 702 coupled to the one or more host systems 714 or a fabric manager, a second interface 708 coupled to one or more volatile memory devices 716, and an optional third interface 712 coupled to one or more non-volatile memory devices 718. The one or more volatile memory devices 716 may be DRAM devices. The integrated circuit 700 may be part of a single-host memory expansion integrated circuit, a multi-host memory pooling integrated circuit coupled to multiple host systems over multiple cache-coherent interconnects, or the like.

In one embodiment, the memory controller 710 and/or the management processor 706 receives a request from one or more host systems 714 over the first interface 702 to initiate cross-host memory sharing. The memory controller 710 may send the request to the authentication circuit 704. The authentication circuit 704 may include processing logic to authenticate requests to initiate memory sharing. The authentication circuit may authenticate requests from the one or more host systems 714 based on a passcode and/or identifiers associated with the one or more host systems 714. In at least one embodiment, the authentication circuit may update one or more internal address translation tables associated with the integrated circuit 700 to enable the one or more host systems 714 to share memory.

In another embodiment, the integrated circuit 700 may include a cryptographic circuit that may encrypt/decrypt data being stored in the one or more volatile memory devices 716 coupled to the management processor 706 via a second interface 708, or one or more non-volatile memory devices 718 coupled to the management processor 706 via a third interface 712.

In another embodiment, the one or more non-volatile memory devices 718 are coupled to a second memory controller (not illustrated) of the integrated circuit 700. In another embodiment, the integrated circuit 700 is a processor that implements the CXL® standard and includes the authentication circuit 704 and memory controller 710. In another embodiment, the integrated circuit 700 may include more or fewer interfaces than three.

It is to be understood that the above description is intended to be illustrative and not restrictive. Many other implementations will be apparent to those of skill in the art upon reading and understanding the above description. Therefore, the disclosure scope should be determined with reference to the appended claims, along with the full scope of equivalents to which such claims are entitled.

In the above description, numerous details are set forth. It will be apparent, however, to one skilled in the art that the aspects of the present disclosure may be practiced without these specific details. In some instances, well-known structures and devices are shown in block diagram form rather than in detail to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

However, it should be borne in mind that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “setting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may include a general-purpose computer selectively activated or reconfigured by a computer program stored in the computer. Such a computer program may be stored in a computer-readable storage medium, such as, but not limited to, any type of disk, including floppy disks, optical disks, CD-ROMs, magnetic-optical disks, read-only memories (ROMs), random-access memories (RAMs), erasable programmable ROMs (EPROMs), electrically erasable programmable ROMs (EEPROMs), magnetic or optical cards, or any type of media suitable for storing electronic instructions, each coupled to a computer system bus.

The algorithms and displays presented herein are not inherently related to any particular computer or other apparatus. Various general-purpose systems may be used with programs in accordance with the teachings herein, or it may prove convenient to construct more specialized apparatuses to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any procedure for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

What is claimed is:

1. A memory buffer device comprising:
processing circuitry to receive a first request from a first initiator to share a region of memory associated with the memory buffer device with a second initiator, wherein the processing circuitry is to:
identify a first passcode associated with the first initiator, wherein the first passcode is useable by at least the first initiator to access the region of memory;
receive a second request from the second initiator to access the region of memory, wherein the second request comprises a second passcode;
authenticate the second request using the first passcode and the second passcode; and
responsive to authentication of the second request, generate a mapping between a host physical address space associated with the second initiator and a physical memory address space associated with the region of memory to enable the second initiator to access the region of memory.

2. The memory buffer device of claim 1, wherein to identify the first passcode associated with the first initiator, the processing circuitry is to generate the first passcode based on an identifier associated with the first initiator.

3. The memory buffer device of claim 1, wherein to identify the first passcode associated with the first initiator, the processing circuitry is to receive the first passcode from the first initiator.

4. The memory buffer device of claim 1, wherein the first passcode is a public-private key pair.

5. The memory buffer device of claim 1, wherein the processing circuitry is further to:
receive a third request from the first initiator to revoke access associated with the second initiator to the region of the memory;
invalidate the first passcode; and
remove the mapping between the host physical address space associated with the second initiator and the physical memory address space associated with the region of memory associated with the memory buffer device.

6. The memory buffer device of claim 1, wherein the processing circuitry is to include the mapping within an internal address translation table associated with the memory buffer device.

7. The memory buffer device of claim 1, wherein the second initiator has read-only access to the region of memory.

8. A memory module comprising:
a plurality of memory devices; and
a memory buffer device operatively coupled to the plurality of memory devices, wherein the memory buffer device is to:
receive a first request from a first initiator to share a region of memory associated with the memory buffer device with a second initiator;
receive a second request from the second initiator to access the region of memory;
authenticate the second request; and
responsive to authentication of the second request, generate a mapping between a host physical address space associated with the second initiator and a physical memory address space associated with the region of memory to enable the second initiator to access the region of memory.

9. The memory module of claim 8, wherein to authenticate the first request, the memory buffer device is to:
identify a first passcode associated with the first initiator; and
authenticate the second request using the first passcode and a second passcode, wherein the second request comprises the second passcode.

10. The memory module of claim 9, wherein to identify the first passcode associated with the first initiator, the memory buffer device is to generate the first passcode based on an identifier associated with the first initiator.

11. The memory module of claim 9, wherein to identify the first passcode associated with the first initiator, the memory buffer device is to receive the first passcode from the first initiator.

12. The memory module of claim 9, wherein the first passcode is a public-private key pair.

13. The memory module of claim 9, wherein the memory buffer device is further to:
receive a third request from the first initiator to revoke access associated with the second initiator to the region of the memory;
invalidate the first passcode; and
remove the mapping between the host physical address space associated with the second initiator and the physical memory address space associated with the region of memory associated with the memory buffer device.

14. The memory module of claim 8, wherein the memory buffer device is to include the mapping within an internal address translation table associated with the memory buffer device.

15. The memory module of claim 8, wherein the second initiator has read-only access to the region of memory.

16. A method comprising:
receiving a first request from a first initiator to share a region of memory associated with a memory buffer device with a second initiator;
identifying a first passcode associated with the first initiator, wherein the first passcode is useable by at least the first initiator to access the region of memory;
receiving a second request from the second initiator to access the region of memory, wherein the second request comprises a second passcode;
authenticate the second request using the first passcode and the second passcode; and
responsive to authenticating the second request, generating a mapping between a host physical address space associated with the second initiator and a physical memory address space associated with the region of memory to enable the second initiator to access the region of memory.

17. The method of claim 16, wherein identifying the first passcode associated with the first initiator comprises generating the first passcode based on an identifier associated with the first initiator.

18. The method of claim 16, wherein identifying the first passcode associated with the first initiator comprises receiving the first passcode from the first initiator.

19. The method of claim 16, wherein the first passcode is a public-private key pair.

20. The method of claim 16, further comprising:
receiving a third request from the first initiator to revoke access associated with the second initiator to the region of the memory;
invalidating the first passcode; and
removing the mapping between the host physical address space associated with the second initiator and the physical memory address space associated with the region of memory associated with the memory buffer device.
